(19) United States
(12) Patent Application Publication
(10) Pub. No.: US 2011/0144778 A1
(43) Pub. Date: Jun. 16, 2011

(54) Smart Audio Plug-in for Enabling Smart Portable Device to be Universal Remote Control

(76) Inventors: Hei Tao Fung, Newark, CA (US); Tony K. Mak, San Francisco, CA (US)

(21) Appl. No.: 12/636,792

(22) Filed: Dec. 14, 2009

(51) Int. Cl. G06F 17/00

(52) U.S. Cl. 700/90

(57) ABSTRACT

A smart audio plug-in comprises an electrical audio signal receiver, a processor of protocol data units carried in the electrical signal, and an infrared signal transmitter. The remote control codes control the electronic appliances such as TV, VCR, Hi-Fi systems, robots, etc. that can decode remote control codes. The smart audio plug-in can be inserted into the audio jack of a smart portable device. The smart portable device such as a smart phone is equipped with powerful CPU, touch screen, networking interface, audio jack, etc. The software application running on the smart portable device can convert the user commands received on the graphical user interface (GUI) into remote control code and transmit unmodulated, or modulated electrical signals such as amplitude modulated, frequency modulated or phase modulated signals that encode the remote control codes through the audio jack to the smart audio plug-in.

### FIELD OF THE INVENTION

The present invention relates to a universal remote control device. More specifically the present invention relates to enabling a smart mobile device to be a universal remote control device.

### BACKGROUND

Nowadays many consumer electronic appliances come with their own distinct and proprietary remote controls. Those remote controls have been using infrared (IR) signals to convey remote control codes corresponding to user commands to the electronic appliances, which have IR remote control decoder embedded. An average household may have a number of remote controls for television, DVD player, hi-fi system, set-top box, etc. In order to alleviate the confusion and hassle of handling multiple remote controls, technologies have been developed to integrate the functionality of all remote controls into one universal remote control. Nowadays, the advanced universal remote controls may have touch screen and user-friendly interface.

Meanwhile, the portable computing device technologies have made a leap. There are advanced mobile phones, PDA, etc., collectively referred to as smart portable devices herein, that possess powerful CPU, touch screen, networking interface, etc. Those smart portable devices are capable of running software applications that can control various device resources. The current invention discloses an apparatus and methods that allow the smart portable devices to convey remote control codes to the electronic appliances.

### SUMMARY OF THE INVENTION

A smart audio plug-in and methods for enabling smart portable devices to be universal remote controls is disclosed. The smart audio plug-in can be inserted into the audio jack of a smart portable device. The smart portable device such as a smart phone is equipped with powerful CPU, touch screen, networking interface, audio jack, etc. The software application running on the smart portable device can convert the user commands received on the graphical user interface (GUI) into remote control codes. The remote control codes can control the electronic appliances such as TV, VCR, Hi-Fi systems, robots, etc. that can decode remote control codes. The software application communicates the remote control codes in unmodulated, or modulated electrical signals such as amplitude modulated, frequency modulated or phase modulated electrical signals through the audio jack to the smart audio plug-in. The smart audio plug-in receives and processes the electrical signals and transmits the remote control codes to the electronic appliances. In our preferred embodiment, the smart portable device sends the remote control codes using modulated infrared (IR) signals.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates an application of the invention disclosed.

FIG. 2 illustrates the format of the protocol data unit (PDU) used to convey a remote control code.

FIG. 3 illustrates how a remote control code is encoded as a protocol data unit.

FIG. 4 illustrates how a protocol data unit is communicated as electrical audio signals.

FIG. 5 shows an embodiment of the smart audio plug-in.

### DETAILED DESCRIPTION OF THE INVENTION

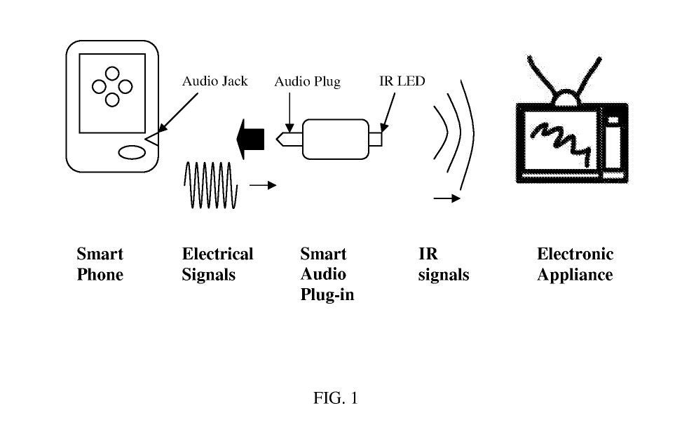

A smart audio plug-in and methods for enabling smart portable devices to be universal remote controls is disclosed. FIG. 1 shows a deployment example of the invention disclosed. The smart portable device such as a smart phone is equipped with powerful CPU, touch screen, networking interface, audio jack, etc. The software application running on the smart portable device can convert the user commands received on the graphical user interface (GUI) into remote control codes specific to the electronic appliance to be controlled. The remote control codes are further encoded into protocol data units (PDUs), and the protocol data units are transmitted in unmodulated, amplitude modulated (AM), frequency modulated (FM), or phase modulated (PM) electrical audio signals. The electrical signals are communicated through the audio jack to the smart audio plug-in. The smart audio plug-in receives the electrical signals and recovers the protocol data units. In our preferred embodiment, the PDUs are transmitted as AM electrical audio signals. That is because amplitude modulation helps reduce interference from other audio signals when the audio jack is in shared use for music or phone calls. Also, in our preferred embodiment, the smart audio plug-in transmits the remote control codes to the electronic appliances using modulated infrared (IR) signals according to the information inside the protocol data units. The electronic appliances receives and demodulates the IR signals to recover the remote control codes.

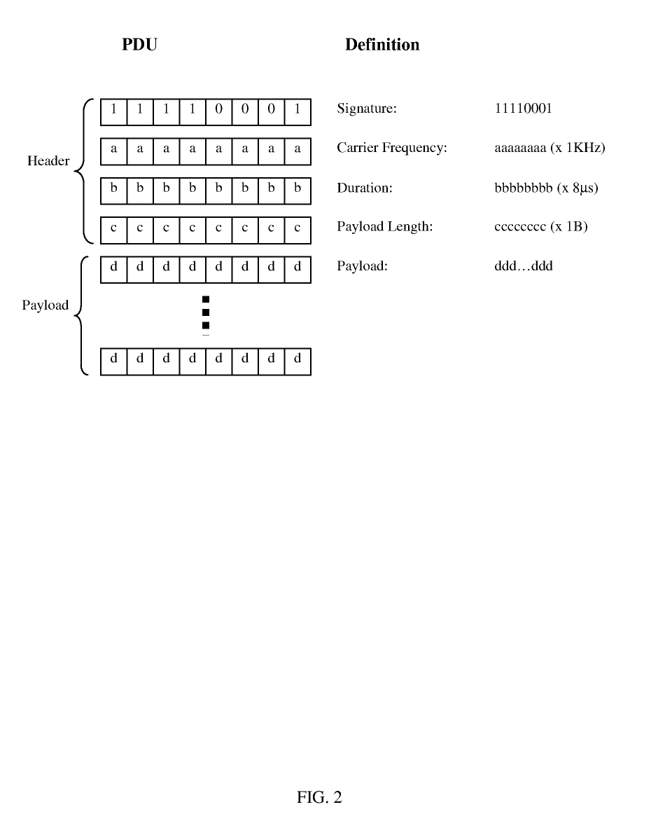

FIG. 2 shows the format of the protocol data unit (PDU) used to convey a remote control code. Each PDU comprises a header of four bytes, followed by a variable length of data bytes representing the logic levels of a remote control code. The PDU header comprises a one-byte signature field, a one-byte carrier frequency field, a one-byte duration field, and a one-byte length field. The signature field has value ‘11110001.’ The carrier frequency field represents the infrared (IR) carrier frequency in units of KHz. The duration field represents the duration of each logic level in the remote control code in units of eight microseconds. The length field represents the number of bytes of the payload to follow. The payload carries the sequence of logic levels of a remote control code.

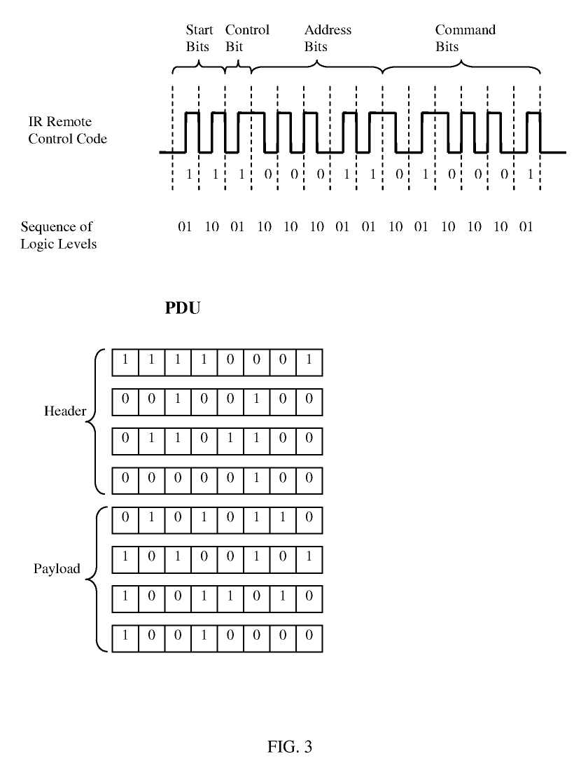

FIG. 3 illustrates how a remote control code is encoded in a PDU. FIG. 3 shows a Philips RC5 IR remote control code, which comprises two starting bits, one toggle bit, five address bits, and six commands bits. In RC5, each bit is represented by a logic level transition. Bit value 1 is represented by transition from level low to level high. Bit value 0 is represented by transition from level high to level low. Therefore, a RC5 IR remote control code can be represented by a sequence of logic levels. The duration of a logic level is electronic appliance specific, and in this example, it is 864 microsecond, and the carrier frequency is 36 KHz representing the IR signal modulation carrier frequency. The sequence of logic levels representing the remote control code has 28 units. It is padded with 4 more units of logic level 0 to make up a four-byte payload.

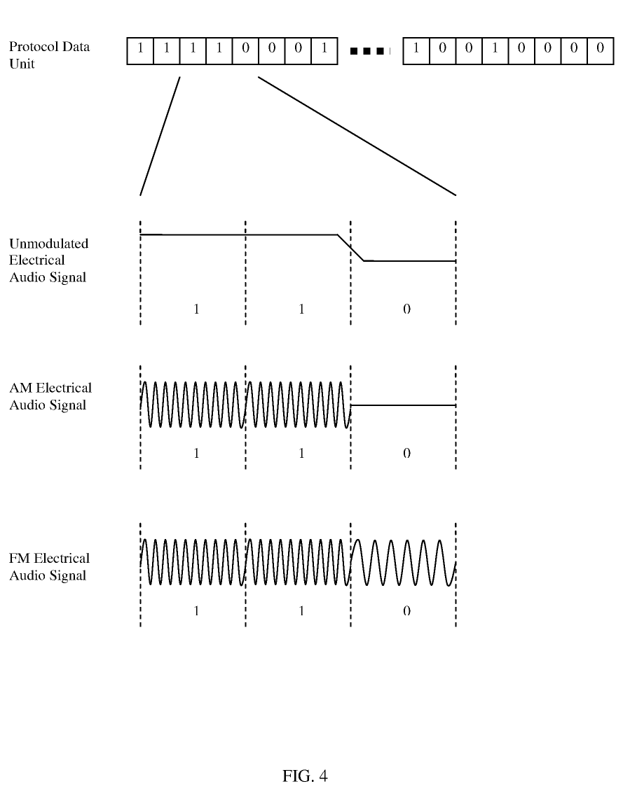

FIG. 4 shows an example of how a protocol data unit is communicated as unmodulated, amplitude modulated, and frequency modulated electrical audio signals. FIG. 4 shows a protocol data unit similar to the one in FIG. 3. When no modulation is in use, the bit value of a PDU is the electrical audio signal level. Bit value 1 is represented by a high voltage, and bit value 0 is represented by zero voltage. The voltage level for each bit lasts for one millisecond.

When amplitude modulation is used, the amplitude of the carrier frequency is a function of the bit value of the protocol data unit. A non-zero amplitude represents bit value 1, and a zero amplitude represents bit value 0. The amplitude duration for each bit value can be one millisecond, for example. Considering the characteristics of the electrical audio signal through the audio jack, the frequency of the carrier electrical audio signal can be one between 10 KHz and 12 KHz.

When frequency modulation is used, the sequence of bit values of the protocol data unit controls the emission of the electrical audio signals of two different carrier frequencies. Considering the characteristics of the electrical audio signal through the audio jack, the frequencies of the two carrier electrical audio signals can be 8 KHz and 12 KHz for bit value 0 and bit value 1, respectively. The duration of emission of one carrier frequency for each bit value can be one millisecond.

The smart audio plug-in receives electrical audio signals from the audio jack. It demodulates the modulated electrical audio signal, if necessary. It recovers the PDU represented in the electrical audio signals. It further uses the duration field value and the carrier frequency field value in the PDU header and the sequence of logic levels of the remote control code in the PDU payload to drive the on/off switch of the IR signal emitter. Consequently, the remote control code is transmitted as modulated IR signals.

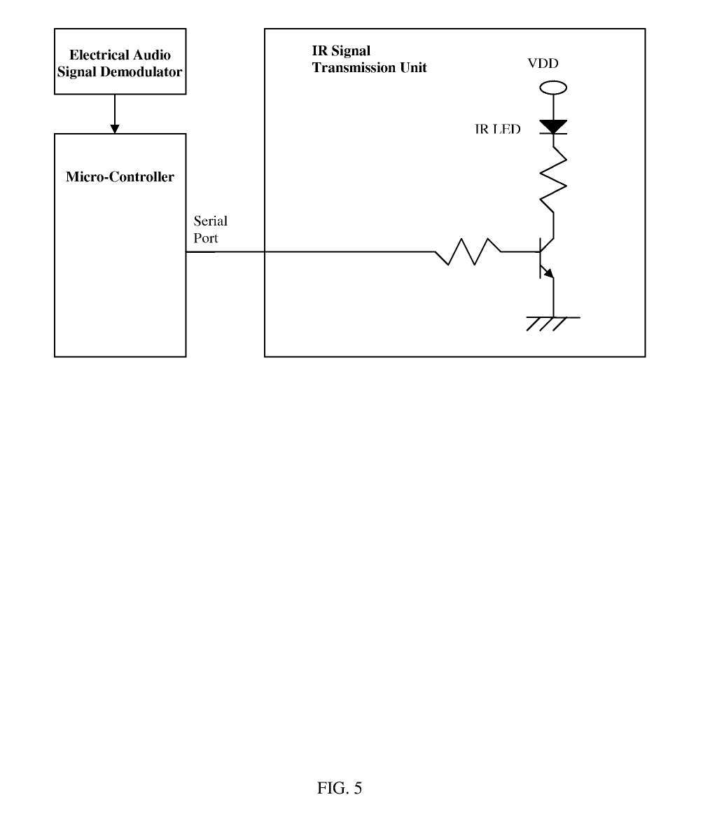

FIG. 5 shows an embodiment of the smart audio plug-in. The smart audio plug-in comprises a demodulator of amplitude modulated (AM) electrical audio signal, a micro-controller, and an IR signal transmission unit. The demodulator converts the electrical audio signal into PDU digital data. The micro-controller implements the aforementioned PDU decoding procedure, and it also controls the on/off switch of the IR signal transmitter via a serial port. The carrier frequency field value controls the IR carrier frequency. The duration field value controls the signal emission power cycle of the modulated IR remote control code. The IR signal transmission unit comprises an IR LED and an on/off switch.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A smart audio plug-in to enable smart portable device to control a plurality of electronic appliances, comprising: receiver of electrical signal; processor of protocol data unit; and transmitter of remote control code.

2. The smart audio plug-in of claim 1, further comprising an audio plug that can connect to an audio jack of said smart portable device.

3. The smart audio plug-in of claim 1, wherein said smart portable device comprises:
an audio jack that conducts electrical signals; software application that converts user inputs to remote control codes specific to the electronic appliance to be controlled; means for converting said remote control codes into said protocol data units; and means for converting said protocol data units into unmodulated or modulated electrical signals.

4. The smart audio plug-in of claim 1, wherein said receiver of electrical signal converts the unmodulated or modulated electrical signals received into said protocol data unit.

5. The smart audio plug-in of claim 1, wherein said protocol data unit comprises a payload that contains the sequence of logic levels representing said remote control code.

6. The smart audio plug-in of claim 1, wherein said protocol data unit further comprises a duration field for controlling the duration of a logic level of said remote control code.

7. The smart audio plug-in of claim 1, wherein said protocol data unit further comprises a carrier frequency field for controlling the modulation frequency in transmitting said remote control code.

8. The smart audio plug-in of claim 1, wherein said processor of protocol data unit uses information inside said protocol data unit to control an on/off switch of said transmitter of remote control code.

9. The smart audio plug-in of claim 1, wherein said transmitter transmits remote control code as modulated infrared signals.

10. A method for enabling smart portable device to control a plurality of electronic appliances, comprising: converting user inputs on said smart portable device to remote control codes specific to electronic appliance under control; converting said remote control code into protocol data unit; transmitting said protocol data unit as unmodulated or modulated electrical signals through audio jack to a smart audio plug-in; receiving said electrical signals on said smart audio plug-in to recover said protocol data unit; and using information in said protocol data unit to control an on/off switch of a transmitter on said smart audio plug-in.

11. The method of claim 10, wherein said smart audio plug connects to an audio jack of said smart portable device.

12. The method of claim 10, wherein said protocol data unit comprises a payload that contains the sequence of logic levels representing said remote control code.

13. The method of claim 10, wherein said protocol data unit further comprises a duration field for controlling the duration of a logic level of said remote control code.

14. The method of claim 10, wherein said protocol data unit further comprises a carrier frequency field for controlling the modulation frequency in transmitting said remote control code.

15. The method of claim 10, wherein said transmitter transmits remote control code as modulated infrared signals.

16. A universal remote control system, comprising: a smart portable device that converts user inputs into remote control codes specific to the electronic appliance to be controlled and transmits protocol data units that encode said remote control codes as electrical signals over an audio jack; and a smart audio plug-in that receives said electrical signals from said audio jack, recovers said protocol data units represented by said electrical signals, and uses information in said protocol data units to control an on/off switch of an infrared signal transmitter.
